(19) United States
(12) Patent Application Publication
(10) Pub. No.: US 2026/0214025 A1
(43) Pub. Date: Jul. 23, 2026

(54) ARTIFICIAL INTELLIGENCE BASED SYSTEM AND METHOD FOR MANAGING CLOUD INFRASTRUCTURE WITH ADAPTIVE KNOWLEDGE GRAPHS

(71) Applicant: xFabric Security Inc, Redmond, WA (US)

(72) Inventors: S M Hasibul Haque, Redmond, WA (US); Ryan Matthew Turner, Seattle, WA (US); S M Mahbub Murshed, Bothell, WA (US); Raida Karim, Seattle, WA (US); Hari Vamsi Yadavalli, Sunnyvale, WA (US)

(21) Appl. No.: 19/449,524

(22) Filed: Jan. 15, 2026

Related U.S. Application Data
(60) Provisional application No. 63/746,328, filed on Jan. 17, 2025.

(51) Int. Cl. H04L 41/16; H04L 41/0631; H04L 41/12; H04L 67/10

(52) U.S. Cl. CPC H04L 41/16; H04L 41/0631; H04L 41/12; H04L 67/10

(57) ABSTRACT

An artificial intelligence based (AI-based) system and method for automatically managing a cloud infrastructure with one or more adaptive knowledge graphs, are disclosed. The AI-based method comprises obtaining cloud data from one or more cloud based data sources; identifying relationships between cloud infrastructure resources based on the cloud data using at least one of: nodes and edges; generating the adaptive knowledge graphs based on the relationships identified, by scanning of cloud APIs, between the cloud infrastructure resources; processing the generated adaptive knowledge graphs to convert the adaptive knowledge graphs into graph data; analyzing at least one of: dependencies, audit configurations, and systems relationships, between the cloud infrastructure resources in the adaptive knowledge graphs; and generating insights into system failures and issues by identifying root causes based on the analyzed at least one of: the dependencies, audit configurations, and systems relationships, between the cloud infrastructure resources.

### CROSS-REFERENCE TO RELATED APPLICATIONS

This Application claims priority from a Provisional patent application filed in the United States of America having Ser. No. 63/746,328 , filed on Jan. 17, 2025, and titled “SYSTEM AND METHOD FOR GENERATING ADAPTIVE KNOWLEDGE GRAPHS OF CLOUD INFRASTRUCTURE”.

### TECHNICAL FIELD

Embodiments of the present disclosure relate to cloud infrastructure management systems and more particularly relate to an artificial intelligence based (AI-based) system and method for managing cloud infrastructure with the generation of one or more adaptive knowledge graphs.

### BACKGROUND

In a realm of modern cloud computing and infrastructure management, organizations increasingly operate across multi-cloud environments and hybrid-cloud environments to optimize performance, cost, and scalability. Managing complex ecosystems involves monitoring vast numbers of interconnected resources such as virtual machines (VMs), containers, databases, and applications. Each resource is configured with unique dependencies, configurations, and policies, thereby creating a dynamic web of interactions that demands comprehensive visibility and effective management. As the organizations scale, the complexity of managing such infrastructures grows exponentially, requiring innovative solutions that may provide real-time insights and adaptive capabilities for efficient operation.

Traditional tools provide certain levels of visibility and configuration validation. However, the traditional tools are limited in scope, focusing on static snapshots and specific cloud providers. The traditional tools lack a unified, dynamic representation of dependencies across diverse environments, making it difficult to track real-time changes and visualize inter-resource relationships. Additionally, the traditional tools rely heavily on manual interventions for mapping dependencies, which are both time-consuming and error-prone, especially in large-scale cloud infrastructures. These limitations hinder the ability of the organizations to identify root causes of failures and security breaches, optimize resource allocation, and make informed decisions during migrations and updates.

Current solutions fail to address critical challenges such as cross-cloud interoperability, scalability, and real-time updates. For instance, cloud infrastructure changes and failures go undetected due to the lack of automated dependency visualization, leading to prolonged downtimes. Furthermore, resource mismanagement is prevalent, as the organizations frequently over-provision resources due to lack of clear visibility into usage patterns, resulting in unnecessary costs. The absence of natural language query support in existing systems limits usability for one or more non-technical users, making it difficult to extract actionable insights from infrastructure data. This gap in functionality highlights the inefficiencies of traditional approaches in managing modern, dynamic infrastructures.

Therefore, there is a pressing need for an improved artificial intelligence based (AI-based) system that may dynamically adapt to the complexities of the multi-cloud environments and the hybrid environments. Such a system should provide an automatic and real-time unified source of truth through one or more adaptive knowledge graphs that model cloud infrastructure resources, dependencies, and configurations, in order to address the above-mentioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence based (AI-based) system for managing a cloud infrastructure with one or more adaptive knowledge graphs, is disclosed.

In an embodiment, the AI-based method comprises obtaining, by one or more hardware processors, cloud data from one or more cloud based data sources. The one or more cloud based data sources comprise at least one of: one or more cloud providers and one or more development and operations services. The AI-based method further comprises identifying, by the one or more hardware processors, one or more relationships between one or more cloud infrastructure resources based on the cloud data using at least one of: one or more nodes and one or more edges.

The AI-based method further comprises generating, by the one or more hardware processors, the one or more adaptive knowledge graphs based on the one or more relationships identified between the cloud infrastructure resources. The one or more relationships are identified by scanning one or more cloud application programming interfaces (APIs). The one or more relationships are identified based on AI-based predictions. The AI-based method further comprises processing, by the one or more hardware processors, the generated one or more adaptive knowledge graphs to convert the one or more adaptive knowledge graphs into graph data.

The AI-based method further comprises analyzing, by the one or more hardware processors, at least one of: one or more dependencies, one or more audit configurations, and one or more systems relationships, between the one or more cloud infrastructure resources in the one or more adaptive knowledge graphs. The AI-based method further comprises generating, by the one or more hardware processors, one or more insights into one or more system failures and issues by identifying one or more root causes based on the analyzed at least one of: the one or more dependencies, the one or more audit configurations, and the one or more systems relationships, between the one or more cloud infrastructure resources in the one or more adaptive knowledge graphs.

In an embodiment, processing the generated one or more adaptive knowledge graphs, comprises: (a) identifying, by one or more hardware processors, the one or more nodes as one or more unprocessed nodes within the one or more adaptive knowledge graphs; (b) adapting, by the one or more hardware processors, each node of the one or more nodes to be traversed through one or more neighboring nodes; (c) analyzing, by the one or more hardware processors, at least one of: one or more relationships between the one or more nodes and metadata associated with each connection between the one or more nodes; (d) determining, by the one or more hardware processors, the one or more dependencies between the one or more nodes based on the analyzed at least one of: the one or more relationships between the one or more nodes and the metadata associated with each connection between the one or more nodes; and (e) labelling, by the one or more hardware processors, the one or more nodes as one or more processed nodes upon determining the one or more dependencies between the one or more nodes.

In another embodiment, the AI-based method further comprising: (a) obtaining, by the one or more hardware processors, one or more queries from the one or more communication devices associated with one or more users; (b) analyzing, by the one or more hardware processors, the one or more queries to determine at least one of: one or more intents and one or more key entities, associated with the one or more queries, using the AI model; (c) integrating, by the one or more hardware processors, the graph data with pre-trained knowledge base upon determining at least one of: the one or more intents and the one or more key entities, associated with the one or more queries; and (d) generating, by the one or more hardware processors, one or more context-aware responses based on the integration of the graph data with the pre-trained knowledge base, using the AI model.

In yet another embodiment, the AI-based method further comprising automatically mapping, by the one or more hardware processors, the one or more dependencies between the one or more nodes to determine an origin of the one or more system failures to mitigate a mean time to resolution (MTTR) in the cloud infrastructure.

In yet another embodiment, the AI-based method further comprising: (a) determining, by the one or more hardware processors, an impact of changes occurred in the cloud infrastructure based on automatic mapping the one or more dependencies between the one or more nodes; (b) adapting, by the one or more hardware processors, the one or more users to evaluate the changes occurred in the cloud infrastructure; and (c) assessing, by the one or more hardware processors, one or more risks associated with the changes occurred in the cloud infrastructure.

In yet another embodiment, the AI-based method further comprising at least one of: automatically, real-time, event-driven and periodically updating, by the one or more hardware processors, the one or more adaptive knowledge graphs when at least one of: new cloud data are ingested and existing cloud data are changed, in the cloud infrastructure.

In yet another embodiment, upon generating the one or more adaptive knowledge graphs using scanning of the cloud APIs, the AI-based method further comprising: (a) performing, by the one or more hardware processors, a breadth first search (BFS) on the one or more adaptive knowledge graphs; (b) generating, by the one or more hardware processors, a natural language description for each node and each edge of the one or more adaptive knowledge graphs using a large language model (LLM); (c) splitting, by the one or more hardware processors, the natural language description into one or more chunks; (d) generating, by the one or more hardware processors, one or more embedding vectors for each chunk of the one or more chunks; (e) storing, by the one or more hardware processors, the one or more embedding vectors in one or more vector databases; (f) receiving, by the one or more hardware processors, the one or more user queries from the one or more communication devices associated with the one or more users; (g) converting, by the one or more hardware processors, the one or more user queries into a query embedding vector; (h) retrieving, by the one or more hardware processors, the stored one or more embedding vectors from the one or more vector databases based on a cosine distance between the query embedding vector and the stored one or more embedding vectors; and (i) appending, by the one or more hardware processors, one or more chunks corresponding to the retrieved one or more embedding vectors to the one or more user queries for generating the one or more context-aware responses using the LLM.

In an aspect, an artificial intelligence based (AI-based) system for automatically managing a cloud infrastructure with one or more adaptive knowledge graphs, is disclosed. The AI-based system includes one or more hardware processors and a memory coupled to the one or more hardware processors. The memory includes a plurality of subsystems in the form of programmable instructions executable by the one or more hardware processors.

The plurality of subsystems comprises a data obtaining subsystem configured to obtain cloud data from one or more cloud based data sources. The one or more cloud based data sources comprise at least one of: one or more cloud providers and one or more development and operations services. The plurality of subsystems further comprises a knowledge graph generating subsystem configured to: (a) identify one or more relationships between one or more cloud infrastructure resources based on the cloud data using at least one of: one or more nodes and one or more edges; and (b) generate the one or more adaptive knowledge graphs based on the one or more relationships identified between the cloud infrastructure resources. The one or more relationships are identified by scanning one or more cloud application programming interfaces (APIs). The one or more relationships are identified based on AI-based predictions.

The plurality of subsystems further comprises a knowledge graph processing subsystem configured to: (a) process the generated one or more adaptive knowledge graphs to convert the one or more adaptive knowledge graphs into graph data; and (b) analyze at least one of: one or more dependencies, one or more audit configurations, and one or more systems relationships, between the one or more cloud infrastructure resources in the one or more adaptive knowledge graphs.

The plurality of subsystems further comprises a root cause analysis subsystem configured to generate one or more insights into one or more system failures and issues by identifying one or more root causes based on the analyzed at least one of: the one or more dependencies, the one or more audit configurations, and the one or more systems relationships, between the one or more cloud infrastructure resources in the one or more adaptive knowledge graphs.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture depicting an artificial intelligence based (AI-based) system for managing a cloud infrastructure with generation of one or more adaptive knowledge graphs, in accordance with an embodiment of the present disclosure;

FIG. 2 illustrates a detailed view of the AI-based system, such as those, as shown in FIG. 1 for managing the cloud infrastructure with the generation of the one or more adaptive knowledge graphs, in accordance with an embodiment of the present disclosure;

FIG. 3 illustrates an exemplary flow diagram representation depicting the generation of the one or more adaptive knowledge graphs of the cloud infrastructure, in accordance with an embodiment of the present disclosure;

FIG. 4 illustrates an exemplary visual representation depicting a user interface associated with one or more communication devices, in accordance with an embodiment of the present disclosure; and

FIG. 5 illustrates a flow chart illustrating an AI-based method for managing the cloud infrastructure with the generation of the one or more adaptive knowledge graphs, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a“ does not, without more constraints, preclude the existence of other devices, sub-systems, additional sub-modules. Appearances of the phrase ”in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

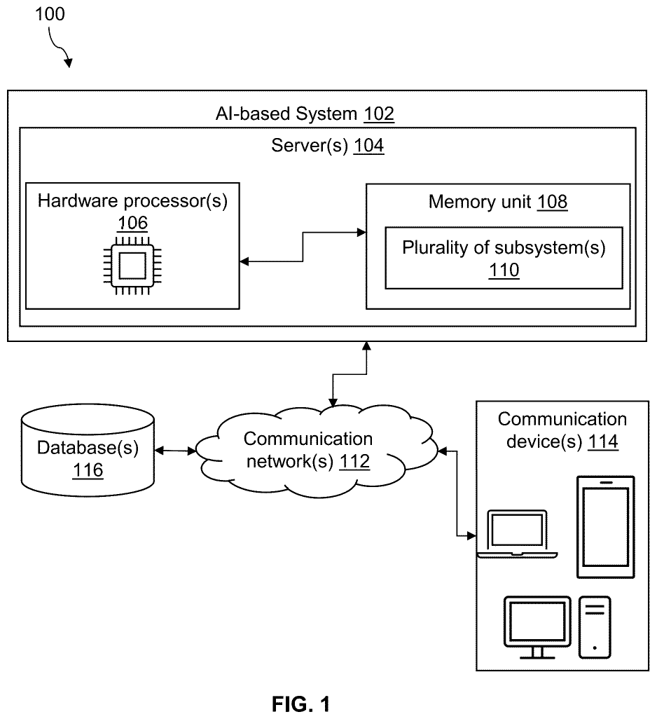

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 illustrates an exemplary block diagram representation of a network architecture 100 depicting an artificial intelligence based (AI-based) system 102 for managing a cloud infrastructure with generation of one or more adaptive knowledge graphs, in accordance with an embodiment of the present disclosure.

According to an exemplary embodiment of the present disclosure, the network architecture 100 may include the AI-based system 102, one or more databases 116, and one or more communication devices 114. The AI-based system 102, the one or more databases 116, and the one or more communication devices 114 may be communicatively coupled via one or more communication networks 112, ensuring seamless data transmission, processing, and decision-making. The AI-based system 102 acts as a central processing unit within the network architecture 100, responsible for generating the one or more adaptive knowledge graphs of the cloud infrastructure. The AI-based system 102 is configured to execute a set of computer-readable instructions that control a plurality of subsystems 110. The AI-based system 102 may be configured as a computer-implemented system.

The AI-based system 102 is initially configured to obtain cloud data (e.g., real-time cloud data) from one or more cloud based data sources. In an embodiment, the one or more cloud based data sources comprise at least one of: one or more cloud providers and one or more development and operations (DevOps) services. The AI-based system 102 is further configured to identify one or more relationships between one or more cloud infrastructure resources based on the cloud data using at least one of: one or more nodes and one or more edges. The AI-based system 102 is further configured to generate the one or more adaptive knowledge graphs based on the one or more relationships identified between the cloud infrastructure resources. In an embodiment, the one or more relationships are identified by scanning one or more cloud application programming interfaces (APIs). In another embodiment, the one or more relationships are identified based on AI-based predictions.

The AI-based system 102 is further configured to process the generated one or more adaptive knowledge graphs to convert the one or more adaptive knowledge graphs into graph data. The AI-based system 102 is further configured to analyze at least one of: one or more dependencies, one or more audit configurations, and one or more systems relationships, between the one or more cloud infrastructure resources in the one or more adaptive knowledge graphs. The AI-based system 102 is further configured to generate one or more insights into one or more system failures and issues by identifying one or more root causes based on the analyzed at least one of: the one or more dependencies, the one or more audit configurations, and the one or more systems relationships, between the one or more cloud infrastructure resources in the one or more adaptive knowledge graphs.

In an exemplary embodiment, the AI-based system 102 comprises one or more servers 104. The one or more servers 104 may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or one or more hardware processors 106.

The one or more servers 104 comprise the one or more hardware processors 106 and a memory unit 108. The memory unit 108 is operatively connected to the one or more hardware processors 106. The memory unit 108 comprises a set of computer-readable instructions in the form of the plurality of subsystems 110, configured to be executed by the one or more hardware processors 106.

In an exemplary embodiment, the one or more hardware processors 106 may include, for example, microprocessors, microcomputers, microcontrollers, digital signal processors, central processing units, state machines, logic circuits, and/or any devices that manipulate data or signals based on operational instructions. Among other capabilities, the one or more hardware processors 106 may fetch and execute computer-readable instructions in the memory unit 108 operationally coupled with the AI-based system 102 for performing tasks such as data processing, input/output processing, and/or any other functions. Any reference to a task in the present disclosure may refer to an operation being or that may be performed on data. The one or more hardware processors 106 are high-performance processors capable of handling large volumes of data and complex computations. The one or more hardware processors 106 may be, but not limited to, at least one of: multi-core central processing units (CPU), graphics processing units (GPUs), and the like, that enhance an ability of the system 102 to process real-time data from one or more sources simultaneously.

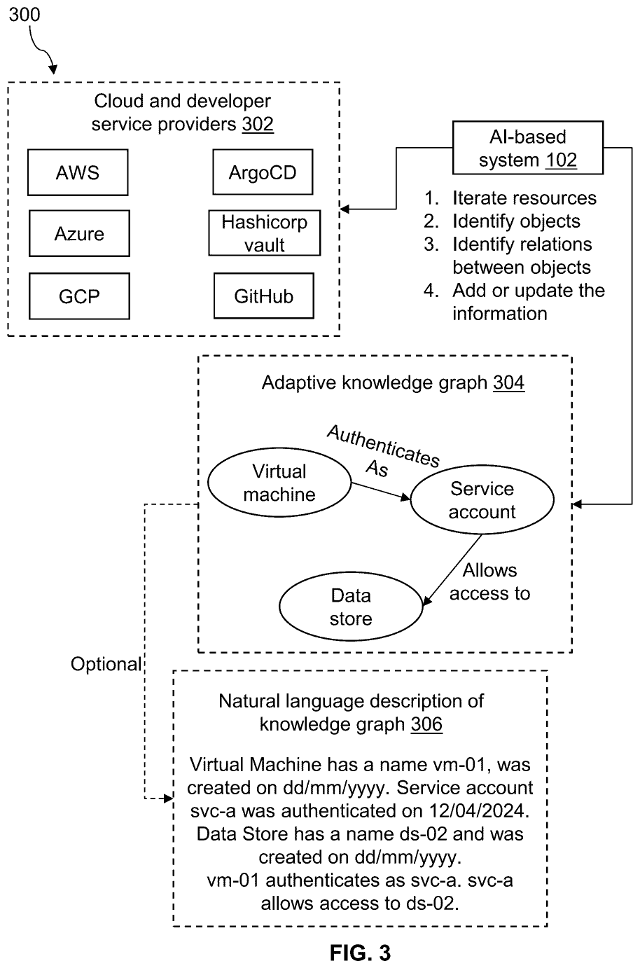

In an exemplary embodiment, the one or more databases 116 may be configured to store and manage data related to various aspects of the AI-based system 102. The one or more databases 116 may store at least one of, but not limited to, the one or more adaptive knowledge graphs, cloud data, graph data, any other information necessary for the functionality and optimization of the AI-based system 102, and the like. The one or more databases 116 serve as a centralized repository for critical data elements that are integral to the secure operation of the AI-based system 102, enabling efficient generation of the one or more adaptive knowledge graphs. The one or more databases 116 enable the AI-based system 102 to dynamically retrieve, analyze, and update the stored data in real-time, for generating the one or more adaptive knowledge graphs of the cloud infrastructure. The one or more databases 116 may include different types of databases such as, but not limited to, relational databases (e.g., Structured Query Language (SQL) databases such as PostgresDB and Oracle® databases), non-Structured Query Language (NoSQL) databases (e.g., MongoDB, Cassandra), time-series databases (e.g., InfluxDB), an OpenSearch database, a graph database, object storage systems (e.g., Amazon®S3), and the like. In an embodiment, the one or more databases 116 me be one or more cloud based data sources comprising at least one of: one or more cloud providers and one or more development and operations services (as shown as cloud and developer service providers 302 in FIG. 3).

In an exemplary embodiment, the one or more communication devices 114 are configured to enable one or more users to interact with the AI-based system 102. The one or more communication devices 114 may be digital devices, computing devices, and/or networks. The one or more communication devices 114 may include, but not limited to, a mobile device, a smartphone, a personal digital assistant (PDA), a tablet computer, a phablet computer, a wearable computing device, a virtual reality/augmented reality (VR/AR) device, a laptop, a desktop, and the like.

In an exemplary embodiment, the one or more communication devices 114 may be associated with, but not limited to, one or more service providers, one or more customers, an individual, an administrator, a vendor, a technician, a specialist, an instructor, a supervisor, a team, an entity, an organization, a company, a facility, a bot, any other user, and combination thereof. The entity, the organization, and the facility may include, but not limited to, an e-commerce company, online marketplaces, service providers, retail stores, a merchant organization, a logistics company, warehouses, transportation company, an airline company, a hotel booking company, a hospital, a healthcare facility, an exercise facility, a laboratory facility, a company, an outlet, a manufacturing unit, an enterprise, an organization, an educational institution, a secured facility, a warehouse facility, a supply chain facility, any other facility/organization and the like.

In an exemplary embodiment, the one or more communication networks 112 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, a combination of networks, and the like. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth®, ZigBee®, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the AI-based system 102 may be implemented by way of a single device or a combination of multiple devices that may be operatively connected or networked together. The AI-based system 102 may be implemented in hardware or a suitable combination of hardware and software.

Though few components and the plurality of subsystems 110 are disclosed in FIG. 1, there may be additional components and subsystems which is not shown, such as, but not limited to, ports, routers, repeaters, firewall devices, network devices, the one or more databases 116, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the AI-based system 102, and the one or more communication devices 114 connected to the one or more databases 116, one skilled in the art can envision that the AI-based system 102, and the one or more communication devices 114 may be connected to several user devices located at various locations and several databases via the one or more communication networks 112.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the AI-based system 102 as is unique to the present disclosure or necessary for an understanding of the present disclosure is depicted and described. The remainder of the construction and operation of the AI-based system 102 may conform to any of the various current implementations and practices that were known in the art.

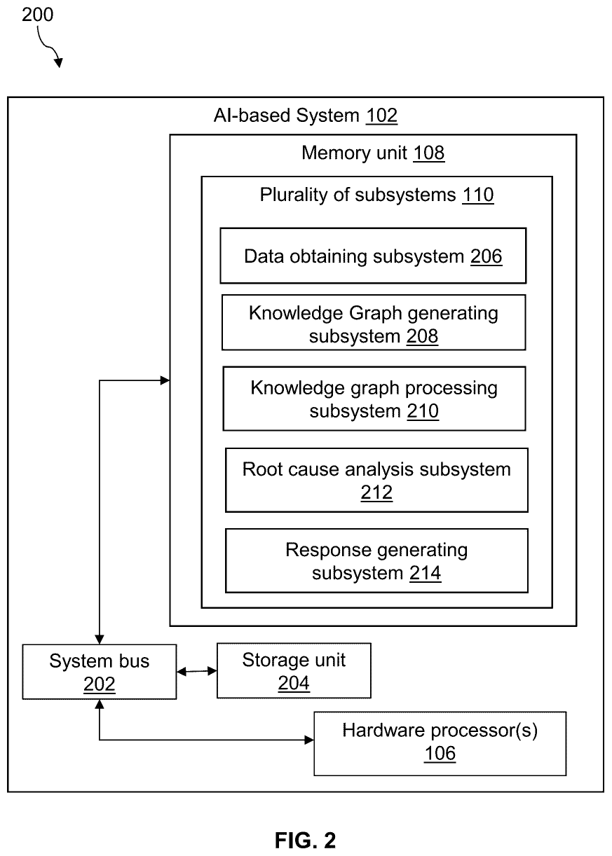

FIG. 2 illustrates a detailed view 200 of the AI-based system 102, such as those, as shown in FIG. 1 for managing the cloud infrastructure with the generation of the one or more adaptive knowledge graphs, in accordance with an embodiment of the present disclosure.

In an exemplary embodiment, the AI-based system 102 comprises the one or more servers 104, the memory unit 108, and a storage unit 204. The one or more hardware processors 106, the memory unit 108, and the storage unit 204 are communicatively coupled through a system bus 202 or any similar mechanism. The system bus 202 functions as the central conduit for data transfer and communication between the one or more hardware processors 106, the memory unit 108, and the storage unit 204. The system bus 202 facilitates the efficient exchange of information and instructions, enabling the coordinated operation of the system 102. The system bus 202 may be implemented using various technologies, including but not limited to, parallel buses, serial buses, and high-speed data transfer interfaces such as, but not limited to, at least one of a: universal serial bus (USB), peripheral component interconnect express (PCIe), and similar standards.

In an exemplary embodiment, the memory unit 108 is operatively connected to the one or more hardware processors 106. The memory unit 108 comprises the plurality of subsystems 110 in the form of programmable instructions executable by the one or more hardware processors 106.

The plurality of subsystems 110 comprises a data obtaining subsystem 206, a knowledge graph generating subsystem 208, a knowledge graph processing subsystem 210, a root cause analysis subsystem 212, and a response generating subsystem 214. The one or more hardware processors 106 associated within the one or more servers 104, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 106 may also include embedded controllers, such as generic or programmable logic devices or arrays, application-specific integrated circuits, single-chip computers, and the like.

The memory unit 108 may be the non-transitory volatile memory and the non-volatile memory. The memory unit 108 may be coupled to communicate with the one or more hardware processors 106, such as being a computer-readable storage medium. The one or more hardware processors 106 may execute machine-readable instructions and/or source code stored in the memory unit 108. A variety of machine-readable instructions may be stored in and accessed from the memory unit 108. The memory unit 108 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 108 includes the plurality of subsystems 110 stored in the form of machine-readable instructions on any of the above-mentioned storage media and may be in communication with and executed by the one or more hardware processors 106.

The storage unit 204 may be a cloud storage or the one or more databases 116 such as those shown in FIG. 1. The storage unit 204 may store, but not limited to, recommended course of action sequences dynamically generated by the AI-based system 102. The action sequences comprise data obtaining, graph generating, natural language representation, root cause analysis, and the like. Additionally, the storage unit 204 may retain previous action sequences for comparison and future reference, enabling continuous refinement of the AI-based system 102 over time. The storage unit 204 may be any kind of database such as, but not limited to, relational databases, dedicated databases, dynamic databases, monetized databases, scalable databases, cloud databases, distributed databases, any other databases, and a combination thereof.

The plurality of subsystems 110 includes the data obtaining subsystem 206 that is communicatively connected to the one or more hardware processors 106. The data obtaining subsystem 206 is configured to obtain the cloud data (e.g., the real-time cloud data) from the one or more cloud based data sources comprising at least one of: the one or more cloud providers and the one or more development and operations (DevOps) services through Application Programming Interface (API) integrations. The data obtaining subsystem 206 is configured to continuously or periodically obtain the real-time cloud data to ensure that the one or more adaptive knowledge graphs are up-to-date. The one or more cloud providers may be, but not restricted to, at least one of: Amazon Web Services®(AWS®), Google Cloud Platform®(GCP®), Azure®, Oracle Cloud®, and the like. The one or more DevOps services may be, but not restricted to, at least one of: Kubernetes®, GitHub®, Argo Continuous Delivery®(ArgoCD®), HashiCorp Vault®, and the like. The API integrations provide an interface for seamless integration with external services and tools. The one or more adaptive knowledge graphs are cloud-agnostic, dynamic schemas that model the cloud infrastructure of the organizations as an evolving graph, representing assets, configurations, dependencies, policies, and the like.

The plurality of subsystems 110 further includes the knowledge graph generating subsystem 208 that is communicatively connected to the one or more hardware processors 106. The knowledge graph generating subsystem 208 is initially configured to identify the one or more relationships between the one or more cloud infrastructure resources based on the cloud data using at least one of: one or more nodes and one or more edges. The knowledge graph generating subsystem 208 is further configured to configured to generate the one or more adaptive knowledge graphs based on the cloud data by representing relationships between cloud infrastructure resources as nodes and edges. In an embodiment, the one or more relationships are identified by scanning one or more cloud application programming interfaces (APIs). In another embodiment, the one or more relationships are identified based on AI-based predictions. The knowledge graph generating subsystem 208 is configured to ensure that the one or more adaptive knowledge graphs reflect the dynamic and evolving nature of the cloud infrastructure.

The nodes represent the cloud infrastructure resources such as, but not constrained to, at least one of: virtual machines, services, the one or more databases 116, configurations, and the like. The edges link the nodes based on relationships such as dependencies and configurations. The knowledge graph generating subsystem 208 is configured to automatically update the one or more adaptive knowledge graphs as at least one of: new cloud data is ingested and existing cloud data is changed. The AI-based system 102 is integrated with a graph database associated with the one or more databases 116 to store and manage the relationships, the graph data, and the one or more adaptive knowledge graphs.

The knowledge graph generating subsystem 208 is configured to ensure that the one or more adaptive knowledge graphs are automatically updated with the real-time cloud data, enabling a live view of the cloud infrastructure of the organizations. In an embodiment, the one or more adaptive knowledge graphs are at least one of: periodically updated with the real-time cloud data, and updated as event driven (i.e., only when there are updates on the one or more adaptive knowledge graphs, as noticed by cloud APIs). The knowledge graph generating subsystem 208 is configured to ensure that the one or more adaptive knowledge graphs are always in sync with an actual state of the cloud infrastructure. The knowledge graph generating subsystem 208 is configured to identify at least one of: new, updated, deleted resources, and the like, and updates the one or more adaptive knowledge graphs accordingly.

The plurality of subsystems 110 further includes the knowledge graph processing subsystem 210 that is communicatively connected to the one or more hardware processors 106. The knowledge graph processing subsystem 210 is configured to process the one or more adaptive knowledge graphs and convert the one or more adaptive knowledge graphs into the graph data (human-readable natural language description). For processing the generated one or more adaptive knowledge graphs, the knowledge graph processing subsystem 210 is initially configured to identify the one or more nodes as one or more unprocessed nodes within the one or more adaptive knowledge graphs. The knowledge graph processing subsystem 210 is further configured to adapt each node of the one or more nodes to be iteratively traversed through one or more neighboring nodes.

The knowledge graph processing subsystem 210 is further configured to analyze at least one of: one or more relationships between the one or more nodes and metadata associated with each connection between the one or more nodes. The knowledge graph processing subsystem 210 is further configured to determine the one or more dependencies between the one or more nodes based on the analyzed at least one of: the one or more relationships between the one or more nodes and the metadata associated with each connection between the one or more nodes. The knowledge graph processing subsystem 210 is further configured to label the one or more nodes as one or more processed nodes to avoid redundant operations upon determining the one or more dependencies between the one or more nodes. In other words, Upon completing the processing of the node and the dependencies, the node is flagged as processed to avoid redundant operations.

The plurality of subsystems 110 further includes the response generating subsystem 214 that is communicatively connected to the one or more hardware processors 106. The response generating subsystem 214 is initially configured to obtain one or more queries from the one or more communication devices 114 associated with one or more users. In other words, the response generating subsystem 214 is configured to enable the one or more users to query about the one or more adaptive knowledge graphs in natural language.

The one or more users may provide one or more queries on the user interface The user interface is associated with the one or more communication devices 114. For example, the one or more queries may be “Is a service account shared across multiple resources?”. The response generating subsystem 214 is configured with one or more large language models (LLMs). The one or more LLMs may include a natural language processing model comprising at least one of: a Generative Pre-trained Transformer (GPT) model, Large Language Model Meta AI (LLaMA), Bidirectional Encoder Representations from Transformers (BERT), Text-to-Text Transfer Transformer (T5), eXtra Long Network (XLNet), and the like.

The response generating subsystem 214 is further configured to analyze the one or more queries to determine at least one of: one or more intents and one or more key entities, associated with the one or more queries, using the AI model. The response generating subsystem 214 is further configured to integrate the graph data with pre-trained knowledge base upon determining at least one of: the one or more intents and the one or more key entities, associated with the one or more queries. The response generating subsystem 214 is further configured to generate one or more context-aware responses (as shown as natural language description of knowledge graph 306 in FIG. 3) based on the integration of the graph data with the pre-trained knowledge base, using the AI model.

In an embodiment, upon generating the one or more adaptive knowledge graphs using scanning of the cloud APIs, the response generating subsystem 214 is configured to perform a breadth first search (BFS) on the one or more adaptive knowledge graphs. The “BFS” refers to a graph traversal algorithm that explores nodes in a graph level by level, starting from a source node and visiting all neighboring nodes at the current depth before proceeding to nodes at the next depth level. In some aspects, BFS may be used to systematically traverse the one or more adaptive knowledge graphs 304 by processing each node and its associated edges in a layer-by-layer manner, ensuring that all nodes at a given distance from the starting node are visited before moving to nodes that are farther away.

The response generating subsystem 214 is further configured to generate a natural language description 306 for each node and each edge of the one or more adaptive knowledge graphs using a large language model (LLM). The response generating subsystem 214 is further configured to split the natural language description 306 into one or more chunks. The response generating subsystem 214 is further configured to generate one or more embedding vectors for each chunk of the one or more chunks. The response generating subsystem 214 is further configured to store the one or more embedding vectors in one or more vector databases. The response generating subsystem 214 is further configured to receive the one or more user queries from the one or more communication devices associated with the one or more users. The response generating subsystem 214 is further configured to convert the one or more user queries into a query embedding vector. The response generating subsystem 214 is further configured to retrieve the stored one or more embedding vectors from the one or more vector databases based on a cosine distance between the query embedding vector and the stored one or more embedding vectors. The response generating subsystem 214 is further configured to append one or more chunks corresponding to the retrieved one or more embedding vectors to the one or more user queries for generating the one or more context-aware responses using the LLM.

For instance, FIG. 3 illustrates an exemplary flow diagram representation 300 depicting the generation of the one or more adaptive knowledge graphs 304 of the cloud infrastructure, in accordance with an embodiment of the present disclosure.

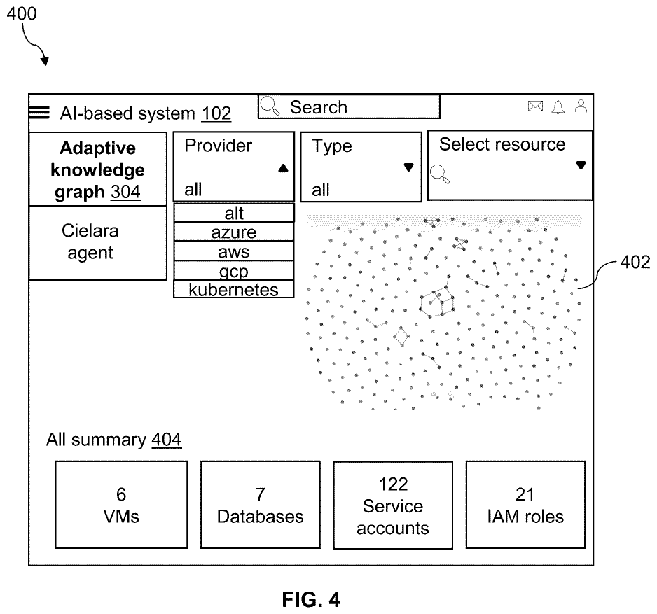

FIG. 3 depicts how a virtual machine authenticates as a service account and how a service account allows access to a data store. This structured knowledge graph associated with the one or more adaptive knowledge graphs 304 enables the generation of the graph data (as shown in FIG. 4 as 402). The graph data 402 provides a human-readable explanation of entities of the one or more adaptive knowledge graphs 304 and the interconnections. For instance, the AI-based system 102 specifies that the virtual machine (vm-01) authenticates as the service account (svc-a) and grants access to the data store (ds-02), along with the metadata such as creation and authentication dates. This seamless integration ensures visibility and traceability across the resources.

In an exemplary embodiment, the user interface provides tools for the one or more users to query and interact with the one or more adaptive knowledge graphs 304. The user interface enables the one or more users to visualize dependencies, audit configurations, and analyze system relationships in an intuitive manner. The user interface enables the one or more users to explore and navigate the one or more adaptive knowledge graphs 304. The tools identify and map interdependencies between the resources in the cloud infrastructure. The user interface provides the tools for configuration audits and failure impact assessments based on the current state of the one or more adaptive knowledge graphs 304. The user interface highlights resource clusters and highly dependent resources. The user interface displays dependencies and relationships, updated dynamically as the cloud infrastructure evolves.

FIG. 4 illustrates an exemplary visual representation 400 depicting a user interface associated with one or more communication devices 114, in accordance with an embodiment of the present disclosure.

As shown in FIG. 4, the user interface includes a dropdown menu to filter the resources by the one or more cloud providers. The user interface showcases a graph visualization 402 where each node represents the resource (e.g., virtual machines, the one or more databases 116, service accounts, and Identity and Access Management (IAM) roles), and the edges represent the relationships between the nodes. The connections illustrate how the resources interact and depend on each other, enabling the one or more users to identify patterns, dependencies, and potential security gaps.

Below the one or more adaptive knowledge graphs 304, the user interface provides a summary 404 of the total resources categorized by type, such as 6 virtual machines, 7 databases associated with the one or more databases 116, 122service accounts, and 21 IAM roles. This summary 404 aids in quickly assessing an inventory and distribution of the resources. The graph visualization and filtering options ensure that the one or more users may drill down into specific one or more cloud providers, resource types, and individual resources, making it easier to manage and optimize cloud and the one or more DevOps services while avoiding resource mismanagement and security vulnerabilities.

The plurality of subsystems 110 further includes the root cause analysis subsystem 212 that is communicatively connected to the one or more hardware processors 106. The root cause analysis subsystem 212 is configured to generate one or more insights into one or more system failures and issues by identifying one or more root causes based on the analyzed at least one of: the one or more dependencies, the one or more audit configurations, and the one or more systems relationships, between the one or more cloud infrastructure resources in the one or more adaptive knowledge graphs 304. The root cause analysis subsystem 212 is configured to speed up incident response and resolution times. The root cause analysis subsystem 212 is further configured to map the failures to the originating cloud infrastructure component and the impact on dependent resources. The root cause analysis subsystem 212 is further configured to provide the tools for tracing the origin of the failures and assessing the impact across the cloud infrastructure. The root cause analysis subsystem 212 is further configured to map the dependencies to pinpoint the origin of failures, reducing a mean time to resolution (MTTR).

The root cause analysis subsystem 212 is further configured to automate a dependency mapping process and simulates the impact of changes in the cloud infrastructure. The root cause analysis subsystem 212 is further configured to enable the one or more users to evaluate the effects of changes and assess the risks associated with cloud infrastructure modifications. The root cause analysis subsystem 212 is further configured to dynamically identify and map the dependencies between cloud infrastructure components, eliminating the need for manual mapping. The root cause analysis subsystem 212 is configured to simulate the impact of changes on dependent resources to assess the potential risks before implementing modifications.

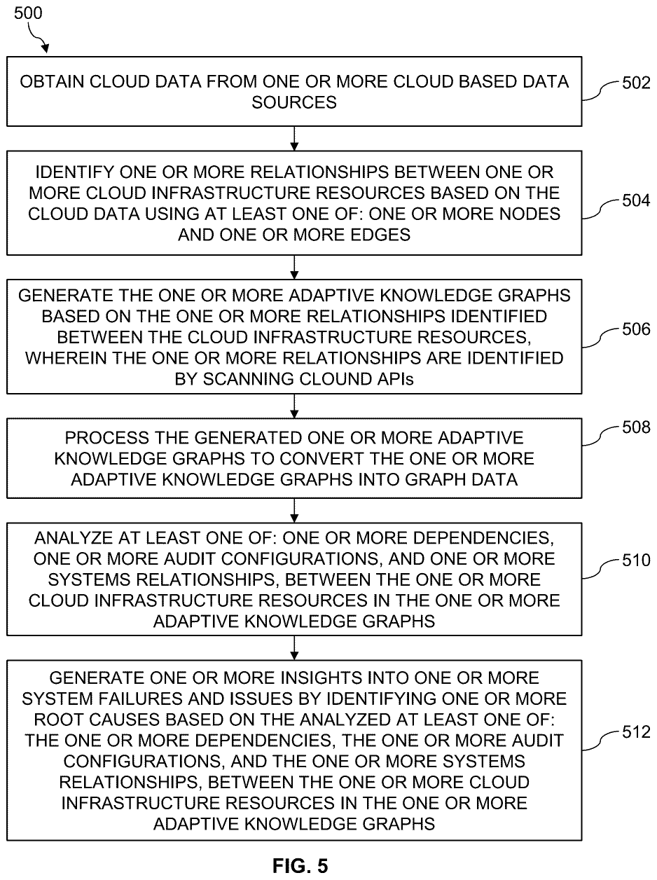

FIG. 5 illustrates a flow chart illustrating an AI-based method 500 for managing the cloud infrastructure with the generation of the one or more adaptive knowledge graphs 304, in accordance with an embodiment of the present disclosure.

At step 502, the cloud data are obtained from the one or more cloud based data sources. In an embodiment, the one or more cloud based data sources may include at least one of: the one or more cloud providers 302 and the one or more development and operations services.

At step 504, the one or more relationships between one or more cloud infrastructure resources are identified based on the cloud data using at least one of: the one or more nodes and the one or more edges.

At step 506, the one or more adaptive knowledge graphs 304 are generated based on the one or more relationships identified between the cloud infrastructure resources. In an embodiment, the one or more relationships are identified by scanning one or more cloud application programming interfaces (APIs). In another embodiment, the one or more relationships are identified based on the AI-based predictions.

At step 508, the generated one or more adaptive knowledge graphs 304 are processed to convert the one or more adaptive knowledge graphs 304 into the graph data 402.

At step 510, at least one of: the one or more dependencies, the one or more audit configurations, and the one or more systems relationships, are analyzed between the one or more cloud infrastructure resources in the one or more adaptive knowledge graphs 304.

At step 512, the one or more insights are generated into the one or more system failures and issues by identifying the one or more root causes based on the analyzed at least one of: the one or more dependencies, the one or more audit configurations, and the one or more systems relationships, between the one or more cloud infrastructure resources in the one or more adaptive knowledge graphs 304.

The AI-based system 102 is configured to identify underutilized cloud resources and over-provisioned cloud resources and provides actionable insights for cost optimization. The AI-based system 102 is configured to focus on improving resource allocation and reducing unnecessary costs. The AI-based system 102 is configured to analyze resource usage patterns to identify inefficiencies such as underused virtual machines, storage, and services. The AI-based system 102 is configured to provide recommendations to optimize resource allocation, such as scaling down and consolidating the underutilized cloud resources.

Numerous advantages of the present disclosure may be apparent from the discussion above. In accordance with the present disclosure, the AI-based system 102 for generating the one or more adaptive knowledge graphs 304 of the cloud infrastructure is disclosed. The AI-based system 102 provides an automatic and real-time unified source of truth, enabling efficient operations, enhanced visibility, and actionable insights into system relationships, usage patterns, and performance for improved decision-making and optimization. An enterprise managing tens of thousands of cloud resources may leverage the one or more adaptive knowledge graphs 304 to instantly simulate the impact of shutting down a legacy application on dependent services. This enables data-driven decisions and prevents downtime, a process that traditional tools may take hours to evaluate.

The AI-based system 102 is configured to provide flexibility for the organizations operating in diverse and multi-cloud environments without requiring separate tools for each cloud provider of the one or more cloud providers. The AI-based system 102 is further configured to provide a comprehensive and intuitive view of a cloud ecosystem, enabling better decision-making and security posture management. The AI-based system 102 is further configured to identify the dependencies and provides actionable insights for cloud migration. The AI-based system 102 is configured to ensure smooth and secure migrations by identifying all necessary cloud infrastructure components and relationships, thereby preventing service disruptions and overlooked security gaps. The AI-based system 102 is further configured to handle the complexity of modern cloud environments, including large-scale cloud infrastructures with numerous interconnected resources.

The AI-based system 102 is configured to adapt effectively with organizational growth and adjusts to changes in cloud environments, providing a long-term value. The AI-based system 102 is further configured to provide context-aware insights and natural language query capabilities, thereby enhancing usability for both one or more technical users associated with the one or more users and one or more non-technical users associated with the one or more users. The AI-based system 102 is further configured to enable real-time visualization (e.g., the graph data 402) of the resources and the relationships. The system facilitates better decision-making for cloud infrastructure optimization and maintenance.

The AI-based system 102 is further configured to support seamless interoperability and management in complex, heterogeneous ecosystems. The AI-based system 102 is further configured to provide actionable insights for incident recovery by identifying cascading effects. The AI-based system 102 is further configured to assess the impact of configuration changes across the dependent resources to minimize operational risks. The AI-based system 102 is further configured to simulate outcomes of changes, reducing errors during cloud infrastructure updates. The AI-based system 102 is further configured to assist the organizations in planning by mapping critical dependencies for business continuity. The AI-based system 102 is further configured to reduce downtime during cloud infrastructure failures by providing a clear restoration path.

The AI-based system 102 is further configured to feed the contextualized graph data 402 to artificial intelligence systems for advanced predictions and optimizations. The AI-based system 102 is further configured to support machine learning workflows by providing structured relationships between the cloud infrastructure components. The AI-based system 102 is further configured to assist in the migration of the cloud infrastructure components from on-premises to the cloud and between the one or more cloud providers by identifying all interdependent cloud infrastructure components. The AI-based system 102 is further configured to support digital transformation initiatives by ensuring secure and efficient transitions.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the AI-based system 102 either directly or through intervening I/O controllers. Network adapters may also be coupled to the AI-based system 102 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/AI-based system 102 in accordance with the embodiments herein. The AI-based system 102 herein comprises at least one processor or central processing unit (CPU). The CPUs are interconnected via the system bus 202 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the AI-based system 102. The AI-based system 102 can read the inventive instructions on the program storage devices and follow these instructions to execute the methodology of the embodiments herein.

The AI-based system 102 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising”, “having”, “containing”, and “including”, and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. An artificial intelligence based (AI-based) method for automatically managing a cloud infrastructure with one or more adaptive knowledge graphs, the AI-based method comprising:
obtaining, by one or more hardware processors, cloud data from one or more cloud based data sources, wherein the one or more cloud based data sources comprise at least one of: one or more cloud providers and one or more development and operations services;
identifying, by the one or more hardware processors, one or more relationships between one or more cloud infrastructure resources based on the cloud data using at least one of: one or more nodes and one or more edges;
generating, by the one or more hardware processors, the one or more adaptive knowledge graphs based on the one or more relationships identified between the cloud infrastructure resources, wherein the one or more relationships are identified by scanning one or more cloud application programming interfaces (APIs);
processing, by the one or more hardware processors, the generated one or more adaptive knowledge graphs to convert the one or more adaptive knowledge graphs into graph data;
analyzing, by the one or more hardware processors, at least one of: one or more dependencies, one or more audit configurations, and one or more systems relationships, between the one or more cloud infrastructure resources in the one or more adaptive knowledge graphs; and
generating, by the one or more hardware processors, one or more insights into one or more system failures and issues by identifying one or more root causes based on the analyzed at least one of: the one or more dependencies, the one or more audit configurations, and the one or more systems relationships, between the one or more cloud infrastructure resources in the one or more adaptive knowledge graphs.

2. The AI-based method of claim 1, wherein processing the generated one or more adaptive knowledge graphs, comprises:
identifying, by one or more hardware processors, the one or more nodes as one or more unprocessed nodes within the one or more adaptive knowledge graphs;
adapting, by the one or more hardware processors, each node of the one or more nodes to be traversed through one or more neighboring nodes;
analyzing, by the one or more hardware processors, at least one of: one or more relationships between the one or more nodes and metadata associated with each connection between the one or more nodes;
determining, by the one or more hardware processors, the one or more dependencies between the one or more nodes based on the analyzed at least one of: the one or more relationships between the one or more nodes and the metadata associated with each connection between the one or more nodes; and
labelling, by the one or more hardware processors, the one or more nodes as one or more processed nodes upon determining the one or more dependencies between the one or more nodes.

3. The AI-based method of claim 1, further comprising:
obtaining, by the one or more hardware processors, one or more queries from the one or more communication devices associated with one or more users;
analyzing, by the one or more hardware processors, the one or more queries to determine at least one of: one or more intents and one or more key entities, associated with the one or more queries, using the AI model;
integrating, by the one or more hardware processors, the graph data with pre-trained knowledge base upon determining at least one of: the one or more intents and the one or more key entities, associated with the one or more queries; and
generating, by the one or more hardware processors, one or more context-aware responses based on the integration of the graph data with the pre-trained knowledge base, using the AI model.

4. The AI-based method of claim 1, further comprising automatically mapping, by the one or more hardware processors, the one or more dependencies between the one or more nodes to determine an origin of the one or more system failures to mitigate a mean time to resolution (MTTR) in the cloud infrastructure.

5. The AI-based method of claim 4, further comprising:
determining, by the one or more hardware processors, an impact of changes occurred in the cloud infrastructure based on automatic mapping the one or more dependencies between the one or more nodes;
adapting, by the one or more hardware processors, the one or more users to evaluate the changes occurred in the cloud infrastructure; and
assessing, by the one or more hardware processors, one or more risks associated with the changes occurred in the cloud infrastructure.

6. The AI-based method of claim 1, further comprising at least one of: automatically, real-time, event-driven and periodically updating, by the one or more hardware processors, the one or more adaptive knowledge graphs when at least one of: new cloud data are ingested and existing cloud data are changed, in the cloud infrastructure.

7. The AI-based method of claim 1, upon generating the one or more adaptive knowledge graphs using scanning of the cloud APIs, further comprising:
performing, by the one or more hardware processors, a breadth first search (BFS) on the one or more adaptive knowledge graphs;
generating, by the one or more hardware processors, a natural language description for each node and each edge of the one or more adaptive knowledge graphs using a large language model (LLM);
splitting, by the one or more hardware processors, the natural language description into one or more chunks;
generating, by the one or more hardware processors, one or more embedding vectors for each chunk of the one or more chunks;
storing, by the one or more hardware processors, the one or more embedding vectors in one or more vector databases;
receiving, by the one or more hardware processors, the one or more user queries from the one or more communication devices associated with the one or more users;
converting, by the one or more hardware processors, the one or more user queries into a query embedding vector;
retrieving, by the one or more hardware processors, the stored one or more embedding vectors from the one or more vector databases based on a cosine distance between the query embedding vector and the stored one or more embedding vectors; and
appending, by the one or more hardware processors, one or more chunks corresponding to the retrieved one or more embedding vectors to the one or more user queries for generating the one or more context-aware responses using the LLM.

8. An artificial intelligence based (AI-based) system for automatically managing a cloud infrastructure with one or more adaptive knowledge graphs, the AI-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a data obtaining subsystem configured to obtain cloud data from one or more cloud based data sources, wherein the one or more cloud based data sources comprise at least one of: one or more cloud providers and one or more development and operations services;
a knowledge graph generating subsystem configured to:
identify one or more relationships between one or more cloud infrastructure resources based on the cloud data using at least one of: one or more nodes and one or more edges; and
generate the one or more adaptive knowledge graphs based on the one or more relationships identified between the cloud infrastructure resources, wherein the one or more relationships are identified by scanning one or more cloud application programming interfaces (APIs);
a knowledge graph processing subsystem configured to:
process the generated one or more adaptive knowledge graphs to convert the one or more adaptive knowledge graphs into graph data; and
analyze at least one of: one or more dependencies, one or more audit configurations, and one or more systems relationships, between the one or more cloud infrastructure resources in the one or more adaptive knowledge graphs; and
a root cause analysis subsystem configured to generate one or more insights into one or more system failures and issues by identifying one or more root causes based on the analyzed at least one of: the one or more dependencies, the one or more audit configurations, and the one or more systems relationships, between the one or more cloud infrastructure resources in the one or more adaptive knowledge graphs.

9. The AI-based system of claim 8, wherein in processing the generated one or more adaptive knowledge graphs, the graph processing subsystem is configured to:
identify the one or more nodes as one or more unprocessed nodes within the one or more adaptive knowledge graphs;
adapt each node of the one or more nodes to be traversed through one or more neighboring nodes;
analyze at least one of: one or more relationships between the one or more nodes and metadata associated with each connection between the one or more nodes;
determine the one or more dependencies between the one or more nodes based on the analyzed at least one of: the one or more relationships between the one or more nodes and the metadata associated with each connection between the one or more nodes; and
label the one or more nodes as one or more processed nodes upon determining the one or more dependencies between the one or more nodes.

10. The AI-based system of claim 8, further comprising a response generating subsystem configured to:
obtain one or more queries from the one or more communication devices associated with one or more users;
analyze the one or more queries to determine at least one of: one or more intents and one or more key entities, associated with the one or more queries, using the AI model;
integrate the graph data with pre-trained knowledge base upon determining at least one of: the one or more intents and the one or more key entities, associated with the one or more queries; and
generate one or more context-aware responses based on the integration of the graph data with the pre-trained knowledge base, using the AI model.

11. The AI-based system of claim 8, wherein the root cause analysis subsystem is further configured to automatically map the one or more dependencies between the one or more nodes to determine an origin of the one or more system failures to mitigate a mean time to resolution (MTTR) in the cloud infrastructure.

12. The AI-based system of claim 11, wherein the root cause analysis subsystem is further configured to:
determine an impact of changes occurred in the cloud infrastructure based on automatic mapping the one or more dependencies between the one or more nodes;
adapt the one or more users to evaluate the changes occurred in the cloud infrastructure; and
assess one or more risks associated with the changes occurred in the cloud infrastructure.

13. The AI-based system of claim 8, wherein the knowledge graph generating subsystem is further configured to at least one of: automatically, real-time, event-driven, and periodically update the one or more adaptive knowledge graphs when at least one of: new cloud data are ingested and existing cloud data are changed, in the cloud infrastructure.

14. The AI-based system of claim 8, upon generating the one or more adaptive knowledge graphs using scanning of the cloud APIs, the response generating subsystem is further configured to:
perform a breadth first search (BFS) on the one or more adaptive knowledge graphs;
generate a natural language description for each node and each edge of the one or more adaptive knowledge graphs using a large language model (LLM);
split the natural language description into one or more chunks;
generate one or more embedding vectors for each chunk of the one or more chunks;
store the one or more embedding vectors in one or more vector databases;
receive the one or more user queries from the one or more communication devices associated with the one or more users;
convert the one or more user queries into a query embedding vector;
retrieve the stored one or more embedding vectors from the one or more vector databases based on a cosine distance between the query embedding vector and the stored one or more embedding vectors; and
append one or more chunks corresponding to the retrieved one or more embedding vectors to the one or more user queries for generating the one or more context-aware responses using the LLM.

15. A non-transitory computer-readable storage medium having instructions stored therein that when executed by one or more hardware processors, cause the one or more hardware processors to execute operations of:
obtaining cloud data from one or more cloud based data sources, wherein the one or more cloud based data sources comprise at least one of: one or more cloud providers and one or more development and operations services;
identifying one or more relationships between one or more cloud infrastructure resources based on the cloud data using at least one of: one or more nodes and one or more edges;
generating the one or more adaptive knowledge graphs based on the one or more relationships identified between the cloud infrastructure resources, wherein the one or more relationships are identified by scanning one or more cloud application programming interfaces (APIs);
processing the generated one or more adaptive knowledge graphs to convert the one or more adaptive knowledge graphs into graph data;
analyzing at least one of: one or more dependencies, one or more audit configurations, and one or more systems relationships, between the one or more cloud infrastructure resources in the one or more adaptive knowledge graphs; and
generating one or more insights into one or more system failures and issues by identifying one or more root causes based on the analyzed at least one of: the one or more dependencies, the one or more audit configurations, and the one or more systems relationships, between the one or more cloud infrastructure resources in the one or more adaptive knowledge graphs.

16. The non-transitory computer-readable storage medium of claim 15, wherein processing the generated one or more adaptive knowledge graphs, comprises:
identifying the one or more nodes as one or more unprocessed nodes within the one or more adaptive knowledge graphs;
adapting each node of the one or more nodes to be traversed through one or more neighboring nodes;
analyzing at least one of: one or more relationships between the one or more nodes and metadata associated with each connection between the one or more nodes;
determining the one or more dependencies between the one or more nodes based on the analyzed at least one of: the one or more relationships between the one or more nodes and the metadata associated with each connection between the one or more nodes; and
labelling the one or more nodes as one or more processed nodes upon determining the one or more dependencies between the one or more nodes.

17. The non-transitory computer-readable storage medium of claim 15, further comprising:
obtaining one or more queries from the one or more communication devices associated with one or more users;
analyzing the one or more queries to determine at least one of: one or more intents and one or more key entities, associated with the one or more queries, using the AI model;
integrating the graph data with pre-trained knowledge base upon determining at least one of: the one or more intents and the one or more key entities, associated with the one or more queries; and
generating one or more context-aware responses based on the integration of the graph data with the pre-trained knowledge base, using the AI model.

18. The non-transitory computer-readable storage medium of claim 15, further comprising automatically mapping the one or more dependencies between the one or more nodes to determine an origin of the one or more system failures to mitigate a mean time to resolution (MTTR) in the cloud infrastructure.

19. The non-transitory computer-readable storage medium of claim 18, further comprising:
determining an impact of changes occurred in the cloud infrastructure based on automatic mapping the one or more dependencies between the one or more nodes;
adapting the one or more users to evaluate the changes occurred in the cloud infrastructure; and
assessing one or more risks associated with the changes occurred in the cloud infrastructure.

20. The non-transitory computer-readable storage medium of claim 15, upon generating the one or more adaptive knowledge graphs using scanning of the cloud APIs, further comprising:
performing a breadth first search (BFS) on the one or more adaptive knowledge graphs;
generating a natural language description for each node and each edge of the one or more adaptive knowledge graphs using a large language model (LLM);
splitting the natural language description into one or more chunks;
generating one or more embedding vectors for each chunk of the one or more chunks;
storing the one or more embedding vectors in one or more vector databases;
receiving the one or more user queries from the one or more communication devices associated with the one or more users;
converting the one or more user queries into a query embedding vector;
retrieving the stored one or more embedding vectors from the one or more vector databases based on a cosine distance between the query embedding vector and the stored one or more embedding vectors; and
appending one or more chunks corresponding to the retrieved one or more embedding vectors to the one or more user queries for generating the one or more context-aware responses using the LLM.
